(19) United States
(12) Patent Application Publication
(10) Pub. No.: US 2008/0134262 A1
(43) Pub. Date: Jun. 5, 2008

(54) DEPI interface device for M-CMTS cable system and method thereof

(75) Inventors: Joon Young Jung, Daejeon-city (KR); O Hyung Kwon, Daejeon-city (KR); Soo In Lee, Daejeon-city (KR)

Correspondence Address: BLAKELY SOKOLOFF TAYLOR & ZAFMAN, 1279 OAKMEAD PARKWAY, SUNNYVALE, CA, 94085-4040, US

(73) Assignee: Electronics and Telecommunications Research Institute

(21) Appl. No.: 11/888,848

(22) Filed: Aug. 1, 2007

(30) Foreign Application Priority Data
Dec. 5, 2006 (KR) 10-2006-0122549

(51) Int. Cl. H04N 7/173; H04N 7/16

(52) U.S. Cl. 725/109; 725/111; 725/144

(57) ABSTRACT

A downstream external PHY interface (DEPI) interface apparatus for a modular-cable modem termination system (M-CMTS) cable system complying with a data over cable service interface specifications (DOCSIS) standard is provided. The DEPI interface apparatus for an M-CMTS cable system complying with the DOCSIS standard includes: an Ethernet interface transmitting Ethernet data packets to and receiving Ethernet data packets from a service providing device including at least one of an M-CMTS core, a video server, and a video encoder; an Ethernet packet analyzer analyzing Ethernet data packets, thereby extracting a control message and classifying the Ethernet data packets into corresponding sessions; a DEPI controller interpreting the extracted control message and completing control connection signaling and session signaling with the service providing apparatus; a transmission data processor extracting transmission data from the Ethernet data packets classified by session and outputting the transmission data as an MPEG-2 transport stream (TS) packet stream; and an output interface outputting the output MPEG-2 TS packet stream to a quadrature amplitude modulation (QAM) modulator of a channel corresponding to the stream.

### CROSS-REFERENCE TO RELATED PATENT APPLICATIONS

This application claims the benefit of Korean Patent Application No. 10-2006-0122549, filed on Dec. 5, 2006, in the Korean Intellectual Property Office, the disclosure of which is incorporated herein in its entirety by reference.

### BACKGROUND OF THE INVENTION

1. Field of the Invention

The present invention relates to a downstream external PHY interface (DEPI) interface apparatus for a cable system having a modular-cable modem termination system (M-CMTS) complying with a data over cable service interface specifications (DOCSIS) standard and a method therefor, and more particularly, to a DEPI interface apparatus for supporting a DEPI interface defined between an M-CMTS core and an edge quadrature amplitude modulation (QAM) modulator (EQAM), and a method therefor.

2. Description of the Related Art

A cable modem termination system (CMTS) is a device which in order to provide communication services, provides connectivity to an Internet protocol (IP) network while interoperating with cable modems of subscribers in a cable network.

FIG. 1 is a diagram illustrating a digital cable system having a CMTS structure according to a conventional technology. Referring to FIG. 1, the conventional CMTS has an integrated CMTS form in which protocols of all layers are performed in one CMTS device.

The integrated CMTS 100 interoperates with cable modems of subscribers in a cable network in order to provide communication services, and provides connectivity to IP networks. The cable network may be a hybrid fiber and coaxial network (HFC).

In other words, since the conventional CMTS has the structure of the integrated CMTS 100, it is impossible to share network resources with other systems. Accordingly, according to the conventional CMTS, even in the case of a broadcasting network device to provide broadcasting services, the device should be implemented such that one quadrature amplitude (QAM) modulator should exist separately for one broadcasting channel.

However, the cable services have recently developed such that a variety of services including data, voice, and video are provided at the same time. Accordingly, headend devices of cable service providers have also developed such that integrated services of data, voice, and video can be provided.

As a result, in order to provide a variety of integrated services, the structure of the CMTS has changed to a more flexible form. A modular-CMTS (M-CMTS) standard which has recently been announced by a DOCSIS standard shows this changing trend.

FIG. 2 is a diagram illustrating a digital cable system having a M-CMTS structure according to a conventional technology. Referring to FIG. 2, unlike the existing the integrated CMTS structure illustrated in FIG. 1, in the M-CMTS system structure complying with the DOCSIS standard, an M-CMTS core apparatus 201 handling protocols of two or more layers and an EQAM apparatus 202 handling one layer are separated.

As a result, the M-CMTS system structure complying with the DOCSIS standard requires a DOCSIS timing server 203 to allow the M-CMTS core 201 and the EQAM apparatus 202 to share common timing information.

The network between the M-CMTS core 201 and the EQAM apparatus 202 is referred to as a converged interconnect network (CIN) 204 and the network is connected through an Ethernet.

A basic protocol used in the CIN network 204 is a layer 2 transport protocol-version 3 (L2TPv3). A downstream external PHY interface (DEPI) basically complies with the L2TPv3.

In general, in this M-CMTS structure, the EQAM 202 can support one or more QAM radio frequency (RF) channels. The M-CMTS structure enables communication services connected to the M-CMTS core apparatus 201 and in addition, provides connection to a video server 205 and a video encoder 206, thereby enabling broadcasting services to be provided.

This means the network resource EQAM 202 can be shared by communication and broadcasting services, which allows more efficient use of network resources. The structure of the cable headend device, as described above, has to be changed to the M-CMTS structure in the future in order to provide a variety of services.

In other words, the existing equipment of cable service providers will be replaced by new equipment and discarded, thereby causing equipment expenses.

In particular, in the case of a service provider providing broadcasting services of tens of channels, the QAM modulator installed for each channel will be discarded, and if an EQAM will be substituted, a substantial amount of cost will be required.

### SUMMARY OF THE INVENTION

The present invention provides an apparatus capable of supporting a downstream external PHY interface (DEPI) that is an interface standard defined between a modular-cable modem termination system (M-CMTS) core and an edge quadrature amplitude modulation (EQAM) device of a cable system having an M-CMTS structure, recently announced by a data over cable service interface specifications (DOCSIS) standard in order to utilize conventional quadrature amplitude modulation (QAM) modulators to reduce cost, thereby enabling a QAM modulator used in a cable system with a conventional CMTS structure, to perform the function of the EQAM device.

The present invention also provides an apparatus supporting a DEPI interface standard defined between an M-CMTS core and an EQAM device. The DEPI interface apparatus interoperates with a conventional QAM device, thereby performing the function of an EQAM device. For this, the DEPI interface apparatus should implement the functions defined in the DEPI standard and interoperate with the conventional QAM device.

Also, a plurality of QAM modulators should be interoperating with one DEPI interface apparatus such that when a CMTS structure is changed to an M-CMTS structure, the cost should be minimized.

According to an aspect of the present invention, there is provided a downstream external PHY interface (DEPI) interface apparatus for a cable system with a modular-cable modem termination system (M-CMTS) structure complying with a data over cable service interface specifications (DOCSIS) standard, the DEPI apparatus including: an Ethernet interface transmitting Ethernet data packets to and receiving Ethernet data packets from a service providing device including at least one of an M-CMTS core, a video server, and a video encoder; an Ethernet packet analyzer analyzing the Ethernet data packets, thereby extracting a control message and classifying the Ethernet data packets into corresponding sessions; a DEPI controller interpreting the extracted control message and completing control connection signaling and session signaling with the service providing device; a transmission data processor extracting transmission data from the Ethernet data packets classified by session and outputting the transmission data as an MPEG-2 transport stream (TS) packet stream; and an output interface outputting the output MPEG-2 TS packet stream to a quadrature amplitude modulation (QAM) modulator of a channel corresponding to the stream.

According to another aspect of the present invention, there is provided a DEPI interface method for a cable system with an M-CMTS structure complying with a DOCSIS standard, the DEPI method including: transmitting Ethernet data packets to and receiving Ethernet data packets from a service providing device including at least one of an M-CMTS core, a video server, and a video encoder; analyzing the Ethernet data packets, thereby extracting a control message and classifying the Ethernet data packets into corresponding sessions; for DEPI control, interpreting the extracted control message and completing control connection signaling and session signaling with the service providing device; in order to process transmission data, extracting transmission data from the Ethernet data packets classified by session and outputting the transmission data as an MPEG-2 TS packet stream; and outputting the output MPEG-2 TS packet stream to a QAM modulator of a channel corresponding to the stream.

According to the present invention, an apparatus capable of supporting a that is an interface standard defined between an M-CMTS core and an EQAM device of a cable system having an M-CMTS structure is provided, thereby enabling a QAM modulator used in a cable system with a conventional CMTS structure, to perform the function of the EQAM device.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a digital cable system having a cable modem termination system (CMTS) structure according to a conventional technology;

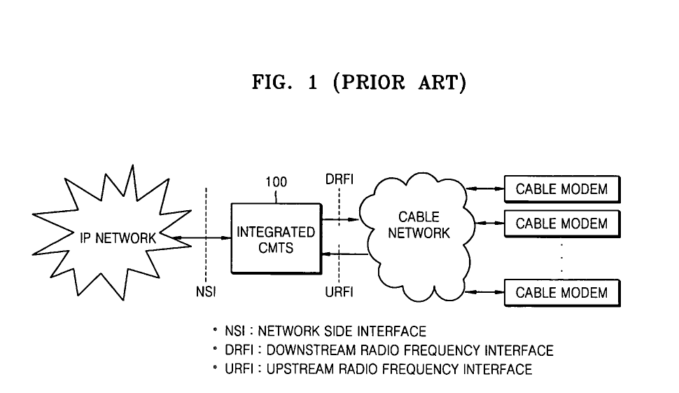

FIG. 2 is a diagram illustrating a digital cable system having a modular-cable modem termination system (M-CMTS) structure according to a conventional technology;

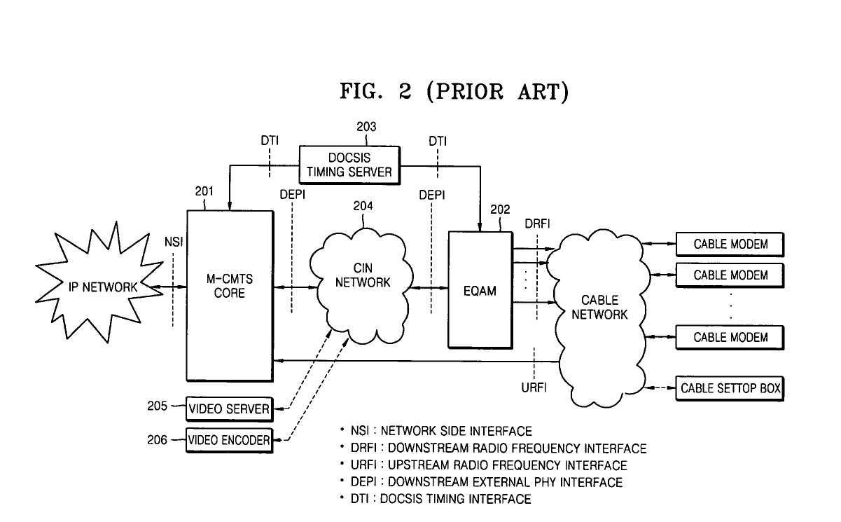

FIG. 3 is a diagram illustrating a digital cable system having an M-CMTS structure to which a downstream external PHY interface (DEPI) apparatus is applied according to an embodiment of the present invention;

FIG. 4 is a diagram illustrating a structure of a DEPI interface apparatus according to an embodiment of the present invention;

FIG. 5 is a diagram illustrating a structure of a transmission data processor of a DEPI interface apparatus according to an embodiment of the present invention; and

FIG. 6 is a flowchart of a DEPI interface method for a cable system having an M-CMTS structure according to an embodiment of the present invention.

### DETAILED DESCRIPTION OF THE INVENTION

The present invention will now be described more fully with reference to the accompanying drawings, in which exemplary embodiments of the invention are shown.

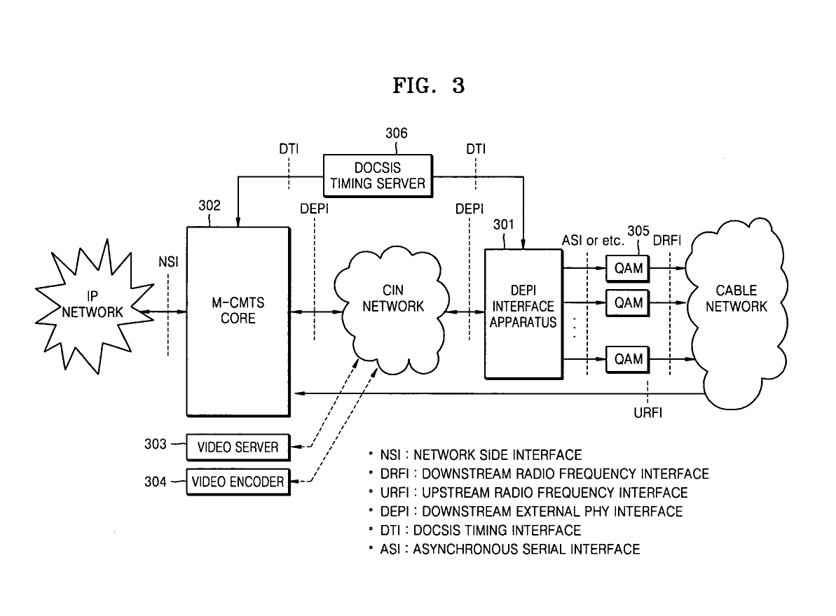

FIG. 3 is a diagram illustrating a digital cable system having a modular-cable modem termination system (M-CMTS) structure to which a downstream external PHY interface (DEPI) apparatus is applied according to an embodiment of the present invention. Referring to FIG. 3, conventional quadrature amplitude modulation (QAM) devices 305 can interoperate with M-CMTS core 302, a video server 303, and a video encoder 304 through a DEPI interface apparatus 301.

In other words, the M-CMTS core 302, the video server 303, and the video encoder 304 can transmit control and data signals with the DEPI interface apparatus 301 through a converged interconnect network (CIN).

Also, in order to provide a cable modem service, the M-CMTS core 302 and the DEPI interface apparatus 301 obtain global timing information from a data over cable service interface specifications (DOCSIS) timing server 306, thereby performing timing synchronization between them.

Each of the M-CMTS core 302, the video server 303, and the video encoder 304 forms a session for control connection and data transmission with the DEPI interface apparatus 301.

Here, a session has a 1:1 mapping relationship with a QAM device 305 of a corresponding channel. That is, each of the M-CMTS core 302, the video server 303, and the video encoder 304 forms a session with the DEPI interface apparatus 301, and then, if a transmission data packet is transmitted to the DEPI interface apparatus 301, the DEPI interface apparatus 301 analyzes the input data packet, classifies the data packet by session, and processes the data packet. Then, the processed transmission data is output to a corresponding QAM device 305.

For the interface between the DEPI interface apparatus 301 and the QAM device 305, a serial interface, such as DVB-ASI or SMPTE 301M, that is used in a QAM modulator for broadcasting is mainly used.

The QAM devices 305 modulate transmission data input from the DEPI interface apparatus 301, and output the modulated data as corresponding RF signals to the cable network. In this way, by interoperating the DEPI interface apparatus 301 with the conventional QAM devices 305, the same function as that of the EQAM can be provided.

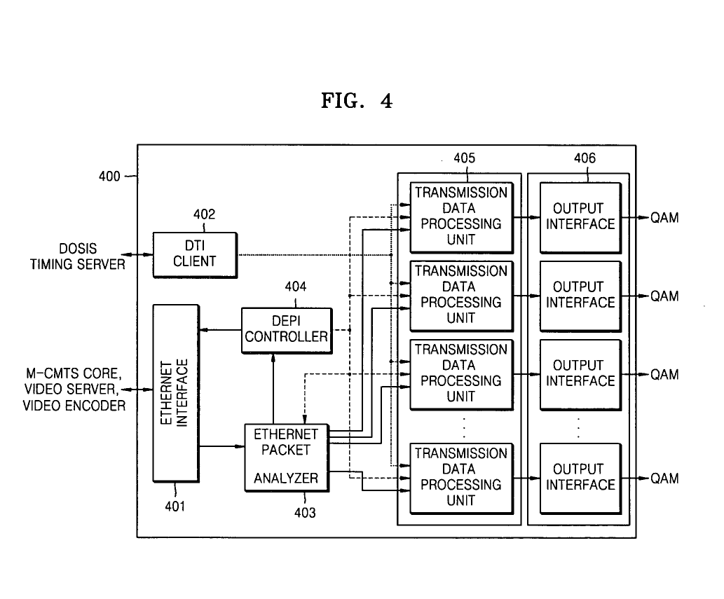

FIG. 4 is a diagram illustrating a structure of a DEPI interface apparatus according to an embodiment of the present invention.

Referring to FIG. 4, the DEPI interface apparatus 400 may include an Ethernet interface 401 transmitting Ethernet data packets to and receiving Ethernet data packets from an M-CMTS core, a video server, and a video encoder, a DOCSIS timing interface (DTI) client 402 obtaining global timing from a DOCSIS timing server, an Ethernet packet analyzer 403 analyzing the input Ethernet data packets, thereby extracting a control message and classifying the input Ethernet data packets by session, a DEPI controller 404 forming control controls and sessions with the M-CMTS core, the video server, and the video encoder, a transmission data processor 405 processing the Ethernet data packets classified by corresponding session, into an MPEG-2 transport stream (TS) packet stream for transmission, according to a control signal, and an output interface 406 outputting the generated MPEG-2 TS packet stream to a QAM modulator corresponding to the stream.

The structure of the DEPI interface apparatus will now be explained in detail. The M-CMTS core, the video server and the video encoder form connections with the DEPI interface apparatus 400 by using control connection signaling and session signaling.

In other words, an Ethernet packet transmitted by any one of the M-CMTS core, the video server, and the video encoder is received through the Ethernet interface 401, and a control message is extracted in the Ethernet packet analyzer 403.

The DEPI controller 404 interprets the control message and generates a response message to the control message, and transmits the response message to the M-CMTS core, the video server or the video encoder through the Ethernet interface 401. In this way, the control connection signaling and the session signaling are completed.

Also, the DTI client 402 receives time information from the DOCSIS timing server and performs synchronization with global timing.

After control connections and sessions between the M-CMTS core, the video server and the video encoder and the DEPI interface apparatus 400 are formed, Ethernet data packets from the M-CMTS core, the video server, and the video encoder are transmitted to the DEPI interface apparatus 400.

The transmitted Ethernet data packets are transferred to the Ethernet packet analyzer 403 through the Ethernet interface 401. The Ethernet packet analyzer 403 analyzes each Ethernet data packet, identifies session information of the Ethernet data packet, and transmits the Ethernet data packet to the transmission data processor 405 of the corresponding session.

For this, according to session information on each connection obtained from the DEPI controller 404, the Ethernet packet analyzer 403 should classify Ethernet data packets into corresponding transmission data processors 405.

If the Ethernet packet analyzer 403 inputs Ethernet data packets to corresponding transmission data processors 405, respectively, each of the transmission data processors 405 extracts transmission data from the Ethernet data packets, and outputs the extracted transmission data as an MPEG-2 TS packet stream with a 188-byte length.

Here, according to the format of the Ethernet data packet input to the transmission data processor 405, the processing by the transmission data processor 405 varies.

When the M-CMTS core generates a DOCSIS MAC packet and then, transmits the packet to the DEPI interface apparatus 400, the format of the Ethernet data packet varies according to whether the transmission mode is an MPEG-TS mode of DEPI (MPT) or a packet stream protocol (PSP) mode.

In the case of the MPT mode, the M-CMTS core transforms the DOCSIS MAC packet into an MPEG-2 TS packet, and then, transmits the packet. However, in the case of the PSP mode, the M-CMTS core directly transmits the DOCSIS MAC packet.

Accordingly, in the case of the MPT mode, the transmission data processor 405 needs to extract and output an MPEG-2 TS packet from a received Ethernet data packet. However, in this case, if the MPEG-2 TS packet includes a DOCSIS sync message, a timestamp value in the DOCSIS sync message should be modified. For this, the transmission data processor 405 receives global timing information from the DTI client 402 and modifies a timestamp value.

In the case of the PSP mode, the transmission data processor 405 extracts a DOCSIS MAC packet from a received Ethernet data packet, and according to the transmission priority of the DOCSIS MAC packet, the DOCSIS MAC packet is transformed into an MPEG-2 TS packet and then output.

In the PSP mode, since the DOCSIC sync message is not generated in the M-CMTS core, the transmission data processor 405 should periodically generate a DOCSIS sync message and insert the message into the MPEG-2 TS packet. The DOCSIS sync message is generated based on the global timing information received from the DTI client 402.

When an Ethernet data packet is transmitted to the DEPI interface apparatus 400 by the video server or the video encoder, the video server generally transmits an MPEG-2 TS packet and therefore the packet is processed in the manner similar to the MPT mode.

However, since the data transmitted from the video server is audio/visual (AN) data, an MPEG-2 TS packet including program clock reference (PCR) information should be extracted and PCR jitter should be corrected. Accordingly, the transmission data processor 405 obtains format information of the input Ethernet data packet from the DEPI controller 404. The DEPI controller 404 obtains the format information of the Ethernet data packet through session signaling.

If an MPEG-2 TS packet stream is output from the transmission data processor 405, the output interface 406 generates an output signal to be output to a QAM device, by using the MPEG-2 TS packet stream.

As the output signal, DVB-ASI or SMPTE 310M that are mainly used by the conventional A/V broadcasting equipment can be used in order to input or output an MPEG-2 TS stream. In this way, data communication between the DEPI interface apparatus 400 and the QAM device is performed.

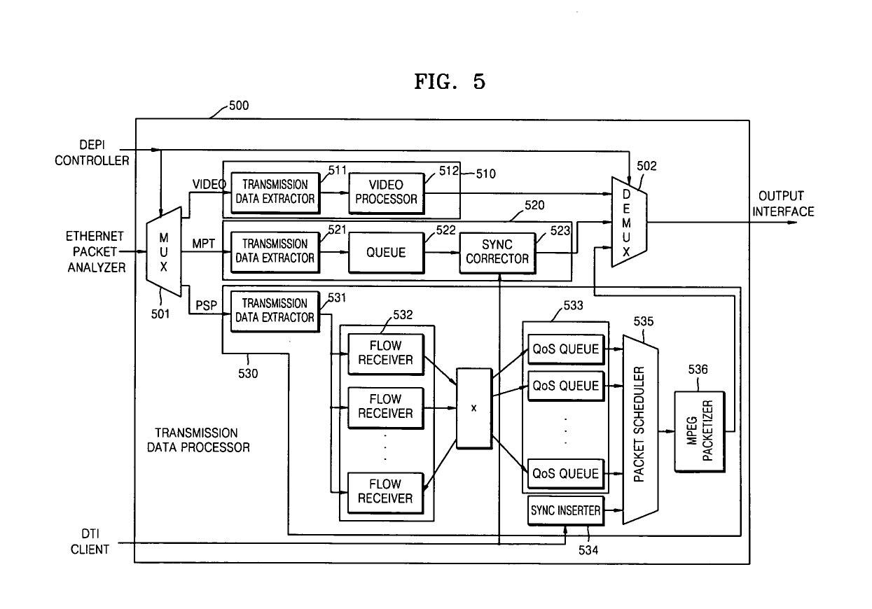

FIG. 5 is a diagram illustrating a structure of a transmission data processor of a DEPI interface apparatus according to an embodiment of the present invention. Referring to FIG. 5, a transmission data processor 500 includes a video mode unit 510, an MPT mode unit 520 and a PSP mode unit 530.

The transmission data processor 500 operates differently with respect to a data mode of an Ethernet data packet input from a packet analyzer.

If an Ethernet data packet is transmitted from a video server or a video encoder, the video mode unit 510 extracts an MPEG-2 TS packet from the Ethernet data packet and outputs the extracted packet.

If an Ethernet packet of an MPT mode transmitted by an M-CMTS core is input, the MPT mode unit 520 extracts an MPEG-2 TS packet from the Ethernet data packet and outputs the extracted packet.

If an Ethernet packet of a PSP mode transmitted by the M-CMTS core is input, the PSP mode unit 520 extracts a DOCSIS MAC packet from the Ethernet data packet and according to the transmission priority of the DOCSIS MAC packet, transforms the extracted packet into an MPEG-2 TS packet, and then outputs the MPEG-2 TS packet.

The DEPI controller 404 of the DEPI interface apparatus 400 illustrated in FIG. 4 controls data modes. That is, the DEPI controller 404 transmits a control signal to a MUX 501 and a DEMUX 502 of the transmission data processor 500 so that data can be processed through a path corresponding to the control mode.

Video data that is transmitted in real-time should satisfy a transmission requirement defined in the MPEG-2 standard. The operation of the transmission data processor 500 in the video mode will now be explained.

If a data packet from the Ethernet packet analyzer 403 illustrated in FIG. 4 is input, data is transmitted through the path of the video mode from the MUX 501 according to a control signal from the DEPI controller 404 illustrated in FIG. 4.

The transmission data in the transmitted data packet is extracted in a transmission data extractor 511.

In this case, in the video mode, a data packet (Ethernet packet) will be constructed in the same manner as the MPT mode, though no standard has been set up. Accordingly, seven 188-bytes-long MPEG-2 TS packets are included in the Ethernet packet, and the MPEG-2 TS packets are sequentially extracted and output to a video processor 512.

The video processor 512 should find a packet containing PCR information in the MPEG-2 TS packets, and correct a PCR value. When the data transmitted from the video server to the DEPI interface 400 illustrated in FIG. 4 goes through the CIN network, PCR jitter occurs.

The range of jitters that is permitted in the MPEG is 500 nanoseconds. Accordingly, in order to make the PCR jitter exist within the permitted range, it is necessary to correct the PCR. Therefore, the video processor 512 corrects the PCR value of the packet having the PCR information and then, outputs the packet.

The MPEG-2 TS packet output from the video processor 512 is transferred to an output interface 406 through the DEMUX 502.

The operation for the MPT mode will now be explained. If a data packet from the Ethernet packet analyzer 403 is input, data is transmitted through the path of the MPT mode from the MUX 501 according to a control signal from the DEPI controller 404.

Transmission data in the data packet is extracted in a transmission data extractor 521.

In this case, in the MPT mode, an Ethernet data packet includes seven 188-bytes-long MPEG-2 TS packets and the MPEG-2 TS packets are sequentially extracted and output to a queue 504.

If the 188-bytes-long MPEG-2 TS packets are input, the queue 522 outputs the packets one by one to a sync corrector 523.

The sync corrector 523 examines whether or not the value of a payload unit start indicate field in the input MPEG-2 TS packet is ‘1’ and the value of the fifth and sixth bytes of the TS packet is 0x00C0. In such a case, the packet includes a DOCSIS sync message.

In the packet including the DOCSIS sync message, a timestamp value in the DOCSIS sync message is corrected to be a current global time which is received from the DTI client 402 illustrated in FIG. 4, and then, the packet is output.

The MPEG-2 TS packet output from the sync modifier 523 is transferred to the output interface 406 illustrated in FIG. 4 through the DEMUX 502.

The operation in the PSP mode is different from that in the MPT mode. In the case of the MPT mode, if one session is established, one data flow exists in the session. However, in the case of the PSP mode, a plurality of flows can exist in one session. The operation of the transmission data processor 500 in the PSP mode will now be explained.

If a data packet from the Ethernet packet analyzer 403 is input, data is transmitted through the path of the PSP mode from the MUX 501 according to a control signal from the DEPI controller 404.

Transmission data in the data packet is extracted in a transmission data extractor 531.

In this case, in the PSP mode, an Ethernet data packet includes a plurality of DOCSIS MAC packets, and the DOCSIS MAC packets are extracted and output to corresponding flow receivers 532, respectively.

Each flow is distinguished by a flow ID field in the L2TP sublayer header in the Ethernet data packet.

In the flow receiver 532, a plurality of DOCSIS MAC packet items extracted from the transmission data extractor 531 are interpreted and recombined into a DOCSIS MAC packet. The DOCSIS MAC packet is transmitted to a QoS queue 533 corresponding to the priority of the recombined MAC packet.

The priority of the MAC packet is distinguished by the type of data included in the MAC packet. That is, if such data as a MAC administration message or voice over Internet protocol (VoIP) data is included, the packet has a higher priority, while non real-time data such as file transmission or file transfer protocol (FTP) data has a lower priority.

If the MAC packets are input to the QoS queues 533, the MAC packets are output form the QoS queues 533 and transmitted to an MPEG packet generator 536 according to the scheduling of a packet scheduler 535.

In this case, since a DOCSIS sync message is not generated in the M-CMTS core in the PSP mode, a sync inserter 534 should periodically generate a sync message.

The MPEG packetizer 536 receiving the MAC packets encapsulates the MAC packet data into a 188-bytes-long MPEG-2 TS packet.

The MPEG-2 TS packet output from the MPEG packet generator 526 is transferred to the output interface 406 through the DEMUX 502.

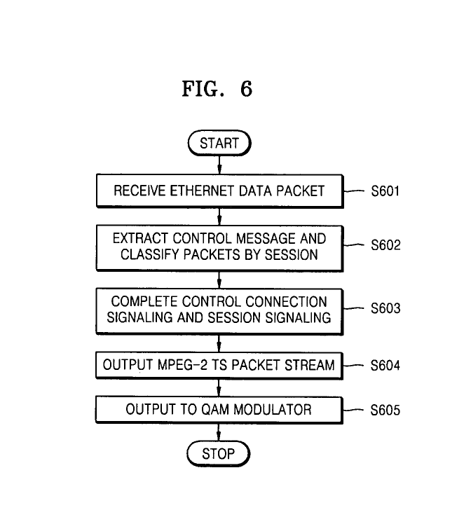

FIG. 6 is a flowchart of a DEPI interface method for a cable system having an M-CMTS structure according to an embodiment of the present invention. Referring to FIG. 6, the operation flow the DEPI interface method for the cable system having the M-CMTS structure complying with the DOCSIS standard.

First, an Ethernet data packet from any one of an M-CMTS core, a video server, and a video encoder is received in operation S601.

By analyzing the Ethernet data packet, a control message is extracted, and the Ethernet data packet is classified into a corresponding session in operation S602.

By analyzing the control message, control connection signaling and session signaling with the M-CMTS core, the video server and the video encoder are completed in operation S603.

Transmission data is extracted from the Ethernet data packet classified by session, and is output as an MPEG-2 TS packet stream in operation S604. The output MPEG-2 TS stream is output to a QAM modulator of a channel corresponding to the stream in operation S605.

According to the present invention, an apparatus capable of supporting the DEPI that is an interface standard defined between an M-CMTS core and an EQAM device of a cable system having an M-CMTS structure, recently announced by a data over cable service interface specifications (DOCSIS) standard is provided, thereby enabling a conventional QAM modulator used in a cable system with a conventional CMTS structure, to perform the function of the EQAM device.

Since reuse of the conventional QAM equipment is enabled according to the present invention, cable service provides can build a digital cable system with an M-CMTS structure which can be used by sharing cable network resources at lower cost.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. A downstream external PHY interface (DEPI) interface apparatus for a cable system with a modular-cable modem termination system (M-CMTS) structure complying with a data over cable service interface specifications (DOCSIS) standard, the DEPI apparatus comprising:
an Ethernet interface transmitting Ethernet data packets to and receiving Ethernet data packets from a service providing device including at least one of an M-CMTS core, a video server, and a video encoder;
an Ethernet packet analyzer analyzing the Ethernet data packets, thereby extracting a control message and classifying the Ethernet data packets into corresponding sessions;
a DEPI controller interpreting the extracted control message and completing control connection signaling and session signaling with the service providing device;
a transmission data processor extracting transmission data from the Ethernet data packets classified by session and outputting the transmission data as an MPEG-2 transport stream (TS) packet stream; and
an output interface outputting the output MPEG-2 TS packet stream to a quadrature amplitude modulation (QAM) modulator of a channel corresponding to the stream.

2. The apparatus of claim 1, further comprising a DOCSIS timing interface (DTI) client receiving time information from a DOCSIS timing server of the cable system with the M-CMTS structure complying with the DOCSIS standard and performing synchronization with global timing.

3. The apparatus of claim 1, wherein the transmission data processor comprises:
an MPEG-transport stream (MPT) mode unit, if the Ethernet data packet classified by session is an Ethernet data packet in an MPT mode, extracting an MPEG-2 transport stream (TS) packet from the Ethernet data packet, and outputting the MPEG-2 TS packet;
a packet stream protocol (PSP) mode unit, if the Ethernet data packet classified by session is an Ethernet data packet in a PSP mode, extracting a DOCSIS MAC packet from the Ethernet data packet, transforming the DOCSIS MAC packet into an MPEG-2 TS packet according to the transmission priority of the DOCSIS MAC packet, and outputting the MPEG-2 TS packet; and
a video mode unit, if the Ethernet data packet classified by session is an Ethernet data packet transmitted from the video server or the video encoder, extracting an MPEG-2 TS packet from the Ethernet data packet, and outputting the MPEG-2 TS packet.

4. The apparatus of any one of claims 1 through 43, wherein the MPEG-2 TS packet is 188 bytes long.

5. A headend system with an M-CMTS structure complying with a DOCSIS standard comprising:
a DEPI interface apparatus classifying an Ethernet data packet received from a service providing device including at least one of an M-CMTS core, a video server, and a video encoder, into a corresponding session, extracting transmission data, and outputting the transmission data as an MPEG-2 TS packet stream; and
at least one or more QAM modulators disposed for a broadcasting channel corresponding to each session in order to transmit the output MPEG-2 TS packet stream to a cable network.

6. A DEPI interface method for a cable system with an M-CMTS structure complying with a DOCSIS standard, the DEPI method comprising:
transmitting Ethernet data packets to and receiving Ethernet data packets from a service providing device including at least one of an M-CMTS core, a video server, and a video encoder;
analyzing the Ethernet data packets, thereby extracting a control message and classifying the Ethernet data packets into corresponding sessions;
for DEPI control, interpreting the extracted control message and completing control connection signaling and session signaling with the service providing device;
in order to process transmission data, extracting transmission data from the Ethernet data packets classified by session and outputting the transmission data as an MPEG-2 TS packet stream; and
outputting the output MPEG-2 TS packet stream to a QAM modulator of a channel corresponding to the stream.

7. The method of claim 6, further comprising receiving time information from a DOCSIS timing server of the cable system with the M-CMTS structure complying with the DOCSIS standard and performing synchronization with global timing.

8. The method of claim 6, wherein the processing of the transmission data comprises:
if the Ethernet data packet classified by session is an Ethernet data packet in an MPT mode, extracting an MPEG-2 TS packet from the Ethernet data packet, and outputting the MPEG-2 TS packet;
if the Ethernet data packet classified by session is an Ethernet data packet in a PSP mode, extracting a DOCSIS MAC packet from the Ethernet data packet, transforming the DOCSIS MAC packet into an MPEG-2 TS packet according to the transmission priority of the DOCSIS MAC packet, and outputting the MPEG-2 TS packet; and
if the Ethernet data packet classified by session is an Ethernet data packet transmitted from the video server or the video encoder, extracting an MPEG-2 TS packet from the Ethernet data packet, and outputting the MPEG-2 TS packet.

9. The method of any one of claims 6 through 8, wherein the MPEG-2 TS packet is 188 bytes long.
